(19) United States
(12) Patent Application Publication
(10) Pub. No.: US 2002/0060718 A1
(43) Pub. Date: May 23, 2002

(54) Method for the formation of pixel elements and print head and inkjet printing device for application of the method

(76) Inventors: Petrus L.J. Welten, Boxmeer (NL); Robert E.A. Braun, Uden (NL); Fulgencio Arjona-Gomez, Eindhoven (NL)

Correspondence Address: Todd Deveau, TROUTMAN SANDERS LLP, Suite 5200, 600 Peachtree St., Atlanta, GA, 30308-2216, US

(21) Appl. No.: 10/044,190

(22) Filed: Jan. 11, 2002

Related U.S. Application Data
(63) Continuation of application No. PCT/NL00/00483, filed on Jul. 10, 2000.

(30) Foreign Application Priority Data
Jul. 16, 1999 (NL) 1012622

(51) Int. Cl. B41J 2/21

(52) U.S. Cl. 347/43

(57) ABSTRACT

In a method for the formation with a print head on a substrate of pixels with a predefined pixel colour by means of droplet deposition, a print head is used which is set up so that, during operation, it performs in one pass a forward and return movement in relation to the substrate. The print head comprises ink nozzles which are aligned in a row behind one another in the direction of movement of the print head, which row comprises an initial series and a final series of ink nozzles, for at least two different first colours, and also a middle series of ink nozzles for at least two different additional colours, which additional colours cannot be formed from the first colours. The method comprises the steps of printing a pixel with a predefined pixel colour by the successive deposition of ink droplets of colours from the row of ink nozzles, in which black is composed as the first and/or the last colour with the aid of ink droplets of the first colours from the ink nozzles.

### CROSS-REFERENCE TO RELATED APPLICATION

This is a continuation application of PCT/NL00/00483 filed Jul. 10, 2000, which PCT application claims priority of Dutch patent application number NL 1012622 filed Jul. 16, 1999, herein incorporated by reference.

### FIELD OF THE INVENTION

The invention relates to the formation of coloured pixels, for example with a colour printing device, such as a colour inkjet printer. More specifically, the invention relates to a method for the formation with a print head on a substrate of pixels with a predefined pixel colour, which print head is set up so that, during operation, it performs in one pass a forward and return movement in relation to the substrate, and which print head comprises ink nozzles which are aligned in a row behind one another in the direction of movement of the print head, which method comprises the allocation of at least two different first colours to ink nozzles of an initial series and to ink nozzles of a final series of the row of ink nozzles, wherein the first colours of the ink nozzles of the initial series and the first colours of the ink nozzles of the final series are identical and are selected in such a way that they can produce the colour black, and wherein the colour sequence of the first colours in the final series is arranged in reverse to the colour sequence of the first colours in the initial series, which method furthermore comprises the step of the deposition of ink droplets with different colours on top of one another to form a pixel with a predefined pixel colour.

### BACKGROUND OF THE INVENTION

In colour printing devices, only a limited number of different ink colours is necessarily available. However, in order to be able to print pixels with any given pixel colour, ink droplets of different colours are combined in a pixel. Through a suitable choice of the ink colours used and the numbers of ink droplets of ink colours of this type for each pixel, a wide variety of pixel colours can be obtained, determined by the ink colours used. In general, the primary ink colours cyan (C), magenta (M) and yellow (Y), and possibly also black (K) are being used. Along with these so-called basic colours (CMYK), additional colours can also be used. The term “process colours” is used for colours which are actually used in a print head or printing process.

In colour printing devices of which the print head performs a forward and return movement in relation to the substrate to be printed, and in which the ink nozzles, seen in the direction of movement of the print head, are aligned in a row behind one another, the problem occurs that the sequence in which ink droplets of different colours produce a pixel is dependent on the direction of movement of the print head. If a pixel colour is composed, for example, from the basic colours yellow and magenta, in which yellow is located in the print head to the right of magenta, if the print head moves from left to right in relation to the substrate to be printed, first a yellow and then a magenta ink droplet will be applied to the pixel. As a result, the magenta ink droplet will lie on the yellow ink droplet. In the opposite direction of movement of the print head, i.e. from right to left, first magenta and then yellow will be applied, so that the yellow ink droplet will lie on the magenta ink droplet.

Reversal of the sequence of the composing ink droplets may cause colour differences. Particularly if, in one movement, a plurality of consecutive image lines (rows of pixels) are formed, this colour difference will be evident in the form of “tracks” in the image. Colour differences of this type are undesirable.

The problem outlined above, involving the occurrence of undesirable colour differences between tracks, can be solved by arranging the different ink nozzles in the print head, seen in the direction of movement of the print head, underneath rather than behind each other. As a result of an arrangement of this type, the droplet deposition sequence will always be the same, irrespective of the direction of movement of the print head. However, an arrangement of this type has, inter alia, the disadvantage that a pixel with a secondary colour (i.e. a colour which is formed by a combination of process colours) is formed in more than one successive pass, whereas deformation of the substrate can occur between the passes. For example, in dimensionally unstable substrates, such as textiles, shrink may occur due to moisture absorption. This causes register problems, which can only be solved through costly additional measures. These register faults as a result of deformation of the substrate can be simply prevented by ensuring that the time between the deposition of the first droplet of a first process colour and the deposition of the last droplet of the last process colour is shorter than the time required for the local deformation of the substrate. For a bidirectional intermittent printing device, this means that the ink nozzles or groups of ink nozzles for each process colour must be positioned close together, seen in the direction of movement of the print head, which may result in undesirable colour differences, as already outlined above. A different simple way to solve this problem of colour differences is to use a print head in which two rows of ink nozzles positioned behind each other are provided, in which each row comprises one ink nozzle for each process colour, and the colour sequences in the rows are mirror images of each other. Given the restricted number of positions for the ink nozzles, as already stated above, a double arrangement of this type is undesirable.

Incidentally, it is noted that a printing method and printing device are known from JP-A-9-277570, in which the colour difference described above is used in order to increase the colour range. For this purpose, this Japanese patent publication discloses a print head for use in a method for printing pixels with a “secondary colour” onto a substrate. A secondary colour of this type is formed by the deposition of droplets of two or three different “primary colours” on top of each other. This known print head comprises ink nozzles or ink nozzle groups A, B, C for the formation of ink droplets with the different primary colours, in which the ink nozzles or groups are arranged in the sequence ABCBA, i.e. symmetrical in relation to the middle ink nozzle, so that, in each direction of movement of the print head, the different colour tones of the secondary colour can be printed. Thus, for a secondary colour, the colour range of this known print head comprises two colour tones, which are dependent on the deposition sequence of the primary colours. Magenta (M), cyan (C) and yellow (Y) are specified as examples of the primary colours.

A disadvantage of this print head according to JP-A-9-277570 is that only a restricted number of (primary) colours are used, as a result of which only part of the colour space can be printed, whereas in practice the requirement in fact exists for further extension of the colour range of a colour printing device through the use of additional colours along with the known basic colours. If the concept according to this Japanese patent application—a symmetrical arrangement of the ink nozzles—is applied to a print head with additional colours along with the aforementioned primary colours, two additional ink nozzles are required for each additional colour. Given the mostly restricted number of available positions for ink nozzles in the print head, the number of extension options is then small. Furthermore, duplication of the process colours leads to higher costs and a print head of larger dimensions.

The invention is intended to eliminate the aforementioned and other disadvantages of the state of the art and to provide a method for the formation with a print head on a substrate of pixels with a predefined pixel colour, which method prevents the occurrence of colour tracks in the printed image, and in which the aforementioned register problems are avoided, and in which, through the use of additional colours, the colour range is increased, but wherein the number of colours to be duplicated, and therefore the number of ink nozzles required for that purpose, is minimised.

The invention is furthermore intended to provide a print head suitable for use in a method of this type, and also a colour printing device.

### SUMMARY OF THE INVENTION

The method of the type specified in the preamble is characterized for this purpose according to the invention by the allocation of at least two different additional colours to ink nozzles located between the initial series and final series of the row of ink nozzles, which additional colours are selected in such a way that they cannot be composed of the first colours, and in which the printing of a pixel with a predefined pixel colour comprises the successive deposition of ink droplets of colours from the row of ink nozzles, in which black is composed as the first and/or the last colour with the aid of ink droplets from the ink nozzles of the initial series or final series.

In the method according to the invention, a print head is thus used in which the first colours, which together can form the colour black, are duplicated, i.e. the rows of ink nozzles comprises an initial series of ink nozzles or ink nozzle groups for the first colours and a final series of ink nozzles or ink nozzle groups for the first colours, in which the sequence of the colours in the initial series is the reverse of the sequence of the final series. In other words, the initial series and final series are mirror images of one another. By composing the colour black from the first colours, the number of ink nozzles to be duplicated is reduced by 1. As known, each colour in the colour space can be formed in the area spanned by three colours, for example two primary colours and one additional colour. This means that the minimum number of first colours to be duplicated is equal to two, without the droplet deposition sequence being dependent on the direction of movement of the print head. The invention is then based on the insight that it is not necessary for the additional colours, of which the ink nozzles (also referred to below as the middle series) are positioned between the initial series and the final series, also to be duplicated, as would be expected on the basis of the concept according to the Japanese patent publication discussed above. By arranging the different additional colours in the middle series, one ink nozzle or ink nozzle group is adequate for each additional colour in the middle series, without the occurrence of undesirable colour differences. The selection of additional colours is determined by the required extension of the colour space. The sequence of the additional colours may be chosen as required, as can that of the first colours in the initial series. Once the sequence of the first colours in the initial series is selected, the sequence thereof in the final series is fixed due to the symmetry requirement. The number of additional colours depends on the number of (remaining) positions for ink nozzles in the print head. The choice of the additional colours (and therefore the position thereof in the colour space in relation to the first colours) is partly determined by the side(s) on which the colour range defined by the first colours is to be extended.

### BRIEF DESCRIPTION OF THE DRAWINGS

The invention will be explained below using the following examples and with reference to the drawing, in which:

FIG. 1 is a schematic diagram showing a substrate to which pixels are applied;

FIG. 2 is a schematic diagram showing a print head;

FIG. 3 is a schematic diagram showing a colour space with first colours and additional colours;

FIG. 4 is a schematic diagram showing a print head according to a first embodiment of the invention;

FIG. 5 is a schematic diagram showing a print head according to a second embodiment of the invention; and

FIG. 6 shows the colour ranges of the print heads according to FIG. 4 and FIG. 5 respectively.

### DESCRIPTION OF THE PREFERRED EMBODIMENTS

According to an embodiment of the present method, the colour black is composed of two first colours. In this embodiment, the initial series and final series of the rows of ink nozzles therefore each comprise two ink nozzles or groups of ink nozzles.

According to a preferred embodiment of the method according to the invention, three first colours are used, which together can form the colour black. A preferred combination comprises the primary colours yellow (Y), magenta (M) and cyan (C). The sequence of these colours in the initial series is not critical, but is partly determined in practice by the required colour tone, for example—from left to right—CMY, so that, in the final series, the sequence is YMC, likewise seen in the same direction.

According to a further preferred embodiment, the additional colours are selected in such a way that, in the colour space, they each have a different combination of first colours as neighbouring colours, i.e. in the case of the three primary colours as first colours and three additional colours, the first additional colour has the first and second primary colours as closest neighbours, the second additional colour has the second and third primary colours as closest neighbours, and the third additional colour has the first and third primary colours as closest neighbours. In this way, the colour range of the primary colours is extended in all directions.

The invention likewise relates to a print head for use in the method according to the invention, and to a colour printing device, which is provided with a print head of this type.

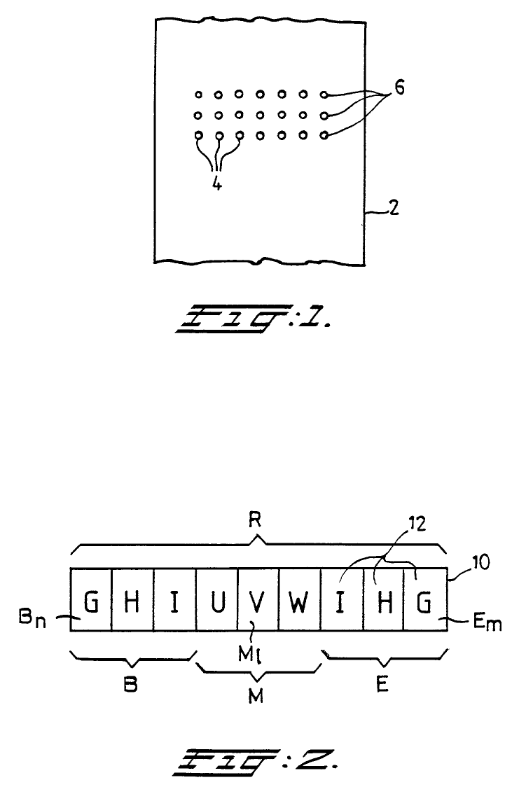

The substrate 2 shown in FIG. 1 may be made from textile, paper and the like. Pixels 4 are applied to the substrate 2 with the aid of a printing device (not shown). The pixels 4 form image lines 6. During operation, a print head (not shown) of the printing device performs, in successive passes, a forward and return first movement in relation to the substrate 2. During each pass, ink droplets are deposited on the substrate 2, as a result of which the pixels 4 of an image line 6 are in each case formed. After each pass, the print head performs a second movement in relation to the substrate 2, which movement, for example, may be performed by transporting the substrate 2. Normally, the first and second movement are at right angles to each other, so that an image line to be applied in the following pass, comprising pixels by means of droplet deposition, will be applied parallel with the preceding, already printed, image line. A printing device as described above is known as a bidirectional, intermittent printer.

A print head comprises a number of ink nozzles, each with its own process colour. The ink nozzles are arranged in a row, the direction of which corresponds to the direction of the first movement of the print head. During one pass, a plurality of ink nozzles generally apply one or more ink droplets to the same pixels. Given that the ink nozzles are arranged behind each other in the direction of movement of the print head, the deposition sequence of ink droplets from different ink nozzles, and therefore of different process colours, is dependent, in a specific pixel, on the direction of movement of the print head.

FIG. 2 is a schematic diagram showing a print head 10 according to the invention with a row R of ink nozzles 12 which is subdivided into an initial series B, wherein the subscript n indicates the position of the ink nozzle concerned in the initial series B. A final series E comprises the same number of ink nozzles as the initial series B, wherein the subscript m again indicates the position of the ink nozzle concerned in the final series E. The ink nozzles B₁₋₃ of the initial series B are allocated, by way of example, to the first colours G, H and I, which together can compose the colour black K. The ink nozzles E₁₋₃ of the final series E are allocated to the same first colours G, H and I, but in reverse order. Between the initial series B and the final series E, a number (according to the invention at least 2) of ink nozzles 12 are present in a middle series M, wherein the subscript 1 again indicates the position of the ink nozzle concerned in the middle series M. These ink nozzles M₁₋₃ are allocated to additional colours U, V and W. These additional colours U, V and W cannot be formed from the first colours G, H and I.

In order to increase the speed of the print head, a plurality of modifications of the print head and the method according to the invention are possible. A first modification relates to an increase in density for the non-duplicated process colours, i.e. the additional colours of the middle series. A second modification relates to an increase in the droplet volume of the non-duplicated process colours. In both modifications, the density of the duplicated process colours is preferably retained, since a reduction in the density thereof results in a reduction in the colour range. The maximum feasible increase in the speed of the print head amounts to twice the speed of the unmodified print head according to the invention.

The selection of the first colours and additional colours in order to form a predefined pixel colour X with the aid of the method according to the invention is illustrated below with reference to two examples.

### EXAMPLE 1

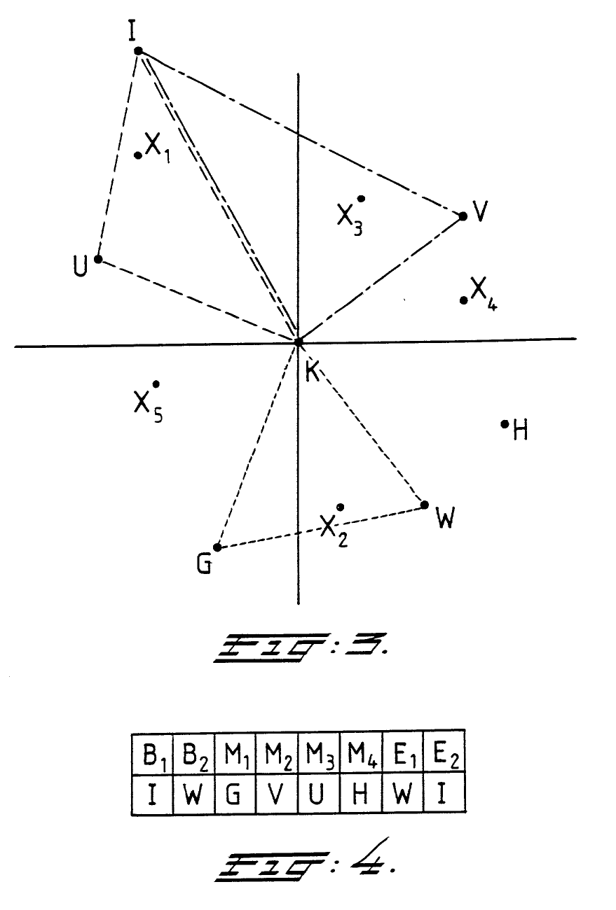

Let us assume a set of colours, comprising the colours G, H and I and the colours U, V and W which lie outside the colour range G, H and I. The colour U has the colours G and I as its neighbouring colours in the colour space, the colour V has the colours H and I as its neighbouring colours, and the colour W has G and H as its closest neighbours. These are schematically shown in FIG. 3, which presents a colour space. If the colour black K is composed of two colours, for example I and W, which in the terminology of the present application are therefore the first colours, then the colours G, H, U and V can be regarded as the additional colours. In this case, the colour space is spanned on the basis of I, W and any chosen third colour, selected from the above (additional) colours.

A pixel with a predefined pixel colour X₁ (see FIG. 3) can be formed with the colours K (black), U and I. The triangle with vertices K, U and I is indicated by a broken dashed line. To prevent any colour difference in the forward and return movement and to form K as the first and/or last colour, a symmetrical structure of the colours needs to be provided, wherein K lies at both ends of the colour sequence, i.e. KUIIUK. It must be noted that U and I can also be transposed. Elimination of an ink nozzle with the colour I and substitution of K with I and W (since K is composed of I and W) produces the colour structure IWUIUWI, from which I in the middle position and one U can be eliminated, resulting in a row R of ink nozzles with the colour sequence IWUWI. Here also, I and W can exchange positions to form black. In the same way, a row R with the sequence IWGWI can be derived for a pixel colour X₂, and a row R with the sequence IWVWI can be derived for a pixel colour X₃. The triangle with vertices K, G and W is indicated by a dotted line, whereas the triangle IVK is represented by a dotted and dashed line. A colour sequence IWGVUHWI therefore meets the basic principles that, during droplet deposition, no colour difference occurs between the forward and return movement of the print head and that the colour range is extended, whereas the number of duplicated ink nozzles in the initial series and final series respectively is minimised.

A print head with a colour sequence of this type is shown schematically in FIG. 4, wherein the position of the ink nozzles is indicated by Bₙ, Eₘ and Mₗ.

However, the above configuration has the disadvantage that not all points in the colour space can be reached. If a pixel colour X₄ (see FIG. 3) needs to be printed, which can only be formed with the colour K and the neighbouring colours V and H, to prevent a colour difference, a colour sequence KVHHVK is required which, following substitution and elimination, transfers to the sequence IWVHVWI. From this, the second ink nozzle for the additional colour V cannot be eliminated without the colour tone of the picture element colour X₄ being dependent on the direction of movement of the print head, since the sequence IWVH can produce a colour X₄ with a different colour tone than the colour sequence IWHV, i.e. the colour range of a print head with a colour sequence as shown in FIG. 4 is to some extent restricted. This phenomenon also occurs for a pixel X₅, which can only be formed with K and the two neighbouring additional colours U and G.

By composing the colour black from 3 first colours, this restriction can also be eliminated, as will become clear from Example 2.

### EXAMPLE 2

This entails the same set of colours (see FIG. 3) as in Example 1, but with the condition that the colour black (K) is composed of the colours G, H and I, i.e. G, H and I are the first colours and U, V and W are the additional colours. In order to be able to form the same picture elements X₁₋₅ as in Example 1, the required colour sequences are as follows:

X₁: GHIUIHG (KUIIUK→KUIUK→GHIUIUIHG→GHIUUIHG→GHIUIHG)

X₂: GHIWIHG

X₃: GHIVIHG

X₄: GHIVIHG

X₅: GHIUIHG.

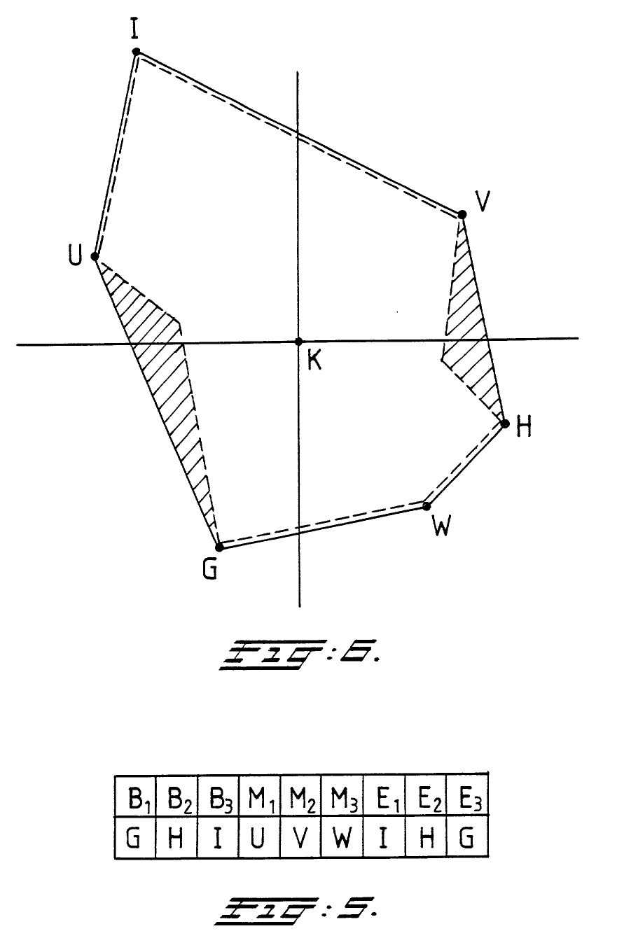

With a colour sequence GHIUVWIHG, the picture elements X₄ and X₅ can therefore also be printed without the occurrence of colour differences. The primary colours cyan (C), magenta (M) and yellow (Y) are advantageously used as the primary colours in a configuration of this type. Examples of the additional colours to be used are orange, blue and green. A print head in which this configuration is present is shown schematically in FIG. 5.

In order to illustrate the difference in the colour range between the embodiments according to Examples 1 and 2, the continuous line in FIG. 6 shows the colour range according to Example 2, while the dashed line shows the colour range according to Example 1. The shaded areas represent the parts of the colour space which can be formed with the embodiment according to Example 2, but not with the embodiment according to Example 1.

In order to increase the speed of the print head, the print head according to the invention can be further modified.

Starting with the print head according to Example 2 with the colour sequence C M Y D E F Y M C, and assuming that the additional colours D, E and F as far as possible have a double density (ink contains twice as much pigment) in relation to the primary colours C, M and Y (or the relevant ink nozzles of the additional colours deliver twice the volume compared with the ink nozzles of the primary colours), and that the speed of the print head, in relation to the excitation time of the droplets, corresponds to a travelled path of 2 pixel units (i.e. double print head speed in relation to the normal situation), an image can be formed in such a way that the even pixels are formed by the YMC final series and the odd pixels by the CMY initial series of the print head. A solid image with sufficient intensity can then be printed using ½ of the additional colours, which additional colours are deposited on the even or odd pixels only. In any event, the eye of an observer is unable to perceive the resulting colour differences between even and odd pixels.

What is claimed is:

1. Method for the formation with a print head on a substrate of pixels with a predefined pixel colour, which print head is set up so that, during operation, it performs in one pass a forward and return movement in relation to the substrate, and which print head comprises ink nozzles which are aligned in a row behind one another in the direction of movement of the print head, which method comprises the allocation of at least two different first colours to ink nozzles of an initial series and to ink nozzles of a final series of the row of ink nozzles, wherein the first colours of the ink nozzles of the initial series and the first colours of the ink nozzles of the final series are identical and are selected in such a way that they can produce the colour black, and wherein the colour sequence of the first colours in the final series is arranged in reverse to the colour sequence of the first colours in the initial series, which method furthermore comprises the step of the deposition of ink droplets with different colours on top of one another, further comprising the allocation of at least two different additional colours to ink nozzles of the row of ink nozzles located between the -initial series and the final series, which additional colours are selected in such a way that they cannot be composed of the first colours, and in which the printing of a pixel with a predefined pixel colour comprises the successive deposition of ink droplets of colours from the row of ink nozzles, in which black is composed as the first and/or the last colour with the aid of ink droplets from the ink nozzles of the initial series or final series.

2. Method according to claim 1, wherein the colour black is composed of two first colours.

3. Method according to claim 1, wherein the colour black is composed of three first colours.

4. Method according to claim 1, wherein the additional colours are selected in such a way that, in the colour space, they each have a different combination of first colours as neighbouring colours.

5. Method according to claim 3, wherein the primary colours yellow, cyan and magenta are selected as the primary colours.

6. Print head for a colour inkjet printing device, which print head comprises a number of ink nozzles arranged in a row for the formation of ink droplets with a colour associated with the relevant ink nozzle, the row comprising an initial series and a final series of ink nozzles for at least two different first colours, wherein the first colours of the ink nozzles of the initial series and the first colours of the ink nozzles of the final series are identical and are selected in such a way that they can produce the colour black and the colour sequence of the ink nozzles in the final series is arranged in reverse to the colour sequence of the ink nozzles in the initial series, wherein the initial series and the final series of ink nozzles are separated by a middle series of ink nozzles for at least two different additional colours, which additional colours cannot be formed from the first colours.

7. Print head according to claim 6, wherein the initial series comprises ink nozzles for two different first colours.

8. Print head according to claim 6, wherein the initial series comprises ink nozzles for three different first colours.

9. Print head according to claims 6, wherein the middle series comprises ink nozzles, to which additional colours are allocated in such a way that, in the colour space, these additional colours each have a different combination of first colours as neighbouring colours.

10. Print head according to claim 8, wherein the primary colours yellow, cyan and magenta are allocated to the ink nozzles of the initial series.

11. Colour inkjet printing device, provided with a print head according to claim 6, for use in the method according to claim 1.
